(19) United States
(12) Patent Application Publication
(10) Pub. No.: US 2013/0075312 A1
(43) Pub. Date: Mar. 28, 2013

(54) Water Purifier

(71) Applicant: Keith Ervin, Hartland, WI (US)

(72) Inventor: Keith Ervin, Hartland, WI (US)

(21) Appl. No.: 13/624,520

(22) Filed: Sep. 21, 2012

Related U.S. Application Data
(60) Provisional application No. 61/537,926, filed on Sep. 22, 2011.

(51) Int. Cl. C02F 1/32

(52) U.S. Cl. 210/138; 250/492.1

(57) ABSTRACT

A water purifier includes an outer shell that at least partially defines an open interior. At least one UVC light emitting diode is at least partially disposed within the open interior. A controller is disposed within the open interior and communicatively connected to the at least one UVC light emitting diode. The controller operates the UVC light emitting diode to emit UVC band electromagnetic energization for a predetermined time period to kill microorganisms found in water about the water purifier.

### CROSS REFERENCE TO RELATED APPLICATION

This application relates to and claims priority from U.S. Provisional Application Ser. No. 61/537,926 filed on Sep. 22, 2011, which is hereby incorporated by reference in its entirety.

### BACKGROUND

The present disclosure is related to the field of fluid processing and purification. More specifically, the present disclosure is related to the purification of water using UVC light.

Water is a well known source of harmful microorganisms. Often drinking water is treated with harsh chemicals in order to eliminate harmful microorganisms that can cause health problems in humans and/or pets. There is growing public concern and caution regarding impact on human health from ingesting the chemicals used to treat water. There are similar concerns regarding the impact of the use of these chemicals on the quality of our natural environment.

Therefore, it is desirable for an alternative manner in which to purify drinking water without the use of chemical additives.

An embodiment of a water purifier includes an outer shell that at least partially defines an open interior. At least one UVC light emitting diode is at least partially disposed within the open interior. A controller is disposed within the open interior and is communicatively connected to the at least one UVC light emitting diode. The controller operates the UVC light emitting diode to emit UVC band electromagnetic energization for a predetermined time period to kill microorganisms and water about the water purifier.

An exemplary embodiment of a water purifier includes an outer shell that at least partially defines an open interior and comprises a connector configured to secure the outer shell of the water purifier to a water container. At least one UVC light emitting diode (LED) is at least partially disposed within the open interior. A controller is disposed within the open interior and is communicatively connected to the at least one UVC LED. The controller operates the UVC LED to emit UVC band electromagnetic energization for a predetermined time period to kill microorganisms in water in the water container. A filter medium is disposed within the open interior of the outer shell to treat water in the water container.

### BRIEF DESCRIPTION OF THE DRAWINGS

FIG. 1 is a side view of a top-half of an embodiment of a water purifier.

FIG. 2 is a side view of a bottom-half of an embodiment of the water purifier.

FIG. 3 is a side view of an assembled embodiment of the water purifier.

FIG. 4 is an end view of one half of an embodiment of the water purifier.

FIG. 5 is an isometric side cut away view of an embodiment of the water purifier.

FIG. 6 is an isometric top cut away view of an embodiment of the water purifier.

FIG. 7 is an exploded isometric view of FIG. 5.

FIG. 8 is an exploded isometric view of the two halves of an embodiment of the water purifier.

FIG. 9 is an isometric view of an embodiment of the water purifier.

FIG. 10 is an alternative isometric view of an embodiment of the water purifier.

FIG. 11 is a side view of an embodiment of the water purifier.

FIG. 12 is an isometric view of an embodiment of the water purifier with the LEDs activated.

FIG. 13 is a further isometric view of an embodiment of the water purifier with the LEDs activated.

FIG. 14 depicts a cutaway view of a drinking container with an activated embodiment of the water purifier.

FIG. 15 is a cross sectional view of a drinking container with an embodiment of the water filter with the LEDs activated.

FIG. 16 depicts an alternative embodiment of the water purifier configured to be connected to the top of a drinking container.

FIG. 17 is a cutaway view of the alternative embodiment of the water purifier connected to the top of a drinking container.

FIG. 18 is a more detailed cross sectional view of the alternative embodiment of the water purifier connected to the top of a drinking container.

FIG. 19 depicts an alternative embodiment of the water purifier configured to be connected to the top of a drinking container.

FIG. 20 depicts an alternative embodiment of the water purifier configured to be connected between two water conveyance apparatus.

FIG. 21 depicts an alternative embodiment of a water purifier configured to be connected to the top of a drinking container.

### DETAILED DISCLOSURE

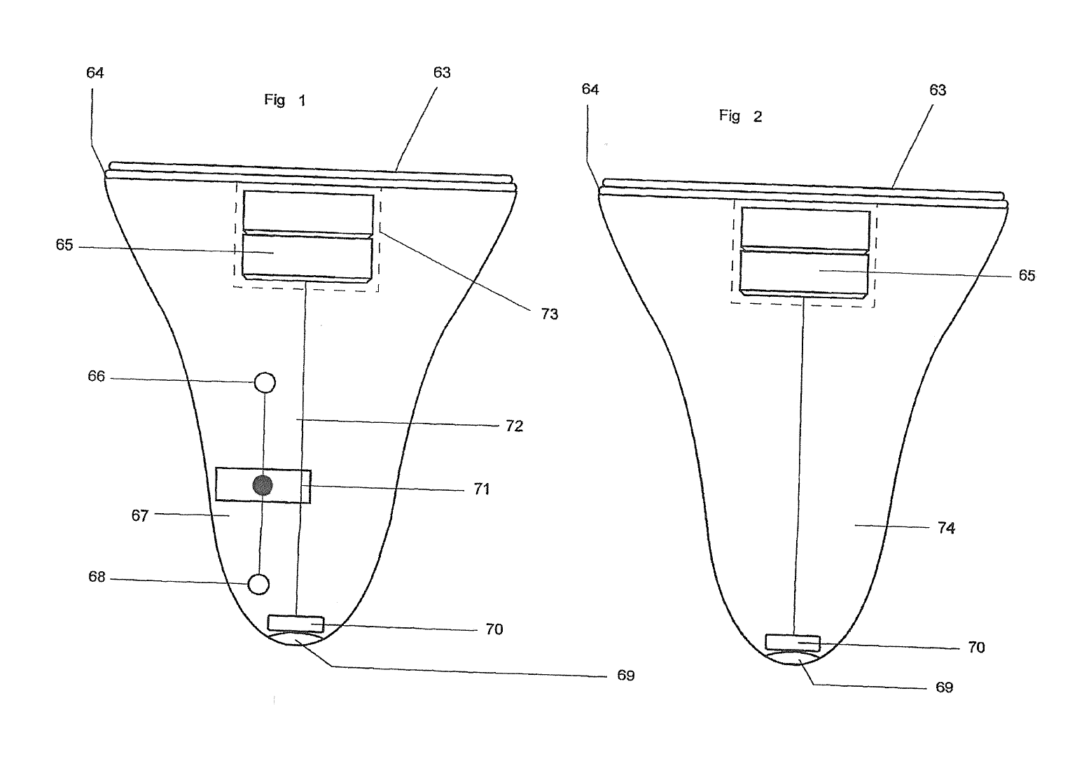

FIGS. 1-4 depict an embodiment a water purifier 11. The purifier 11 is constructed in two halves, an upper half 67 depicted in FIG. 1 and a lower half 74 depicted in FIG. 2. The upper half 67 is constructed of a polycarbonate outer shell. The upper half 67 includes UVC LEDs 69 (ultraviolet wavelength C light emitting diodes, e.g. 250-280 nm wavelength). In one embodiment, the UVC LEDs 69 have an external surface or lens that comprises quartz crystal to maximize ultraviolet light transmission. In the alternative, the external surface or lens can be any other material or shape such as would maximize UVC transmission. The upper half 67 further includes LED chips 70, which exemplarily may be semiconductor chips or AIN wafers, a battery compartment 73, batteries 65, LED wiring 72, and a controller 71. In alternative embodiments, the outer shell is constructed with a quartz crystal or any other lens material that would improve the UVC transmissive properties of the purifier 11, in still further embodiments, the outer shell is a composite material that includes polycarbonate and quartz crystal. Those of ordinary skill in the art will recognize alternative materials for the construction of the purifier 11, that are considered to be within the scope of this disclosure.

The controller 71 may be any of a variety of known microprocessors or microcontrollers. The controller 71 is further communicatively connected to a computer readable medium (not depicted) programmed with computer readable code. The computer readable medium may be an integral part of the controller 71 or may be a separate component. In one embodiment, the computer readable medium is non-volatile memory. The controller 71 executes the computer readable code stored on the computer readable medium and upon execution carries out the functions as described herein. The controller 71 may perform either timing functions or control the operation of the purifier 11. In some embodiments, the controller 71 performs both timing and operational functions.

The upper half 67 further includes threads 64 for engaging mating threads 64 of the lower half 74. At least one rubber seal 63 further creates a water tight seal when the upper half 67 and lower half 74 are threadedly connected. The external surface of the UVC LEDs 69 may be constructed of quartz crystal to maximize UVC light transmission. The upper half 67 further includes colored LEDs that operate as a timer indicator 66 and a power indicator 68.

FIG. 2 depicts the lower half 74 of the water purifier 11. It too, is constructed of a polycarbonate (or other material) outer shell which contains UVC LEDs 69, LED chips/semiconductor chips/AIN wafers 70, a battery compartment 73, batteries 65, and LED wiring 72.

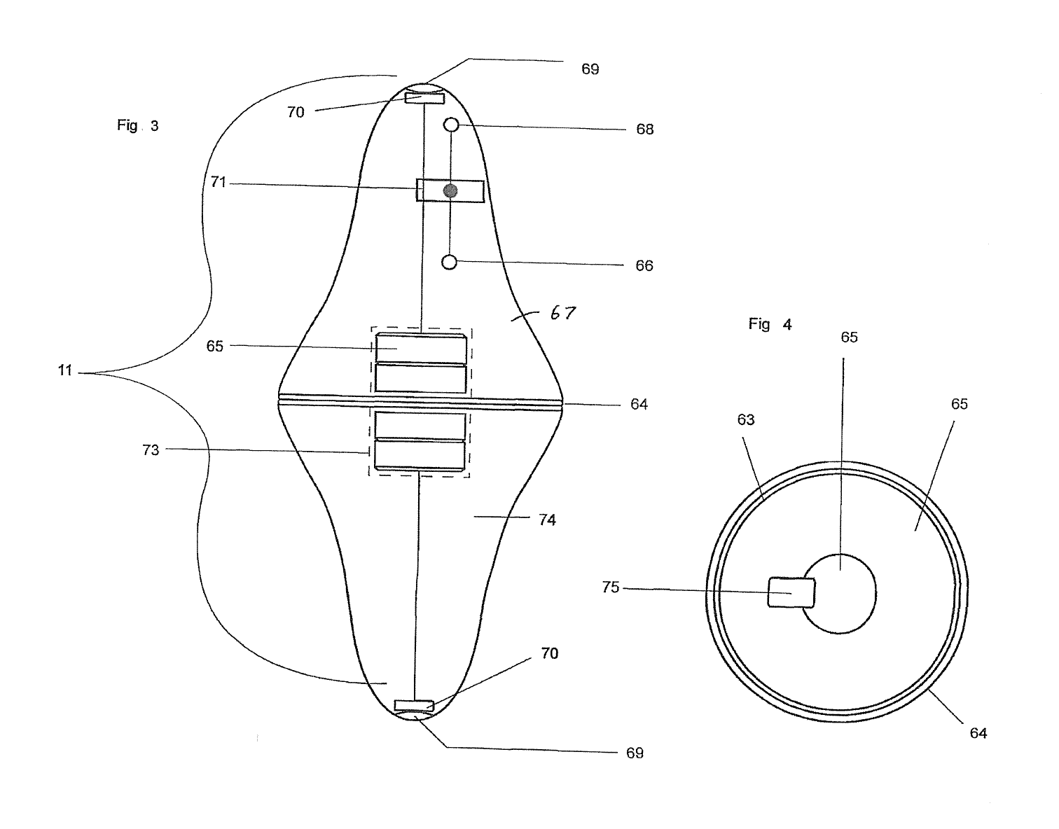

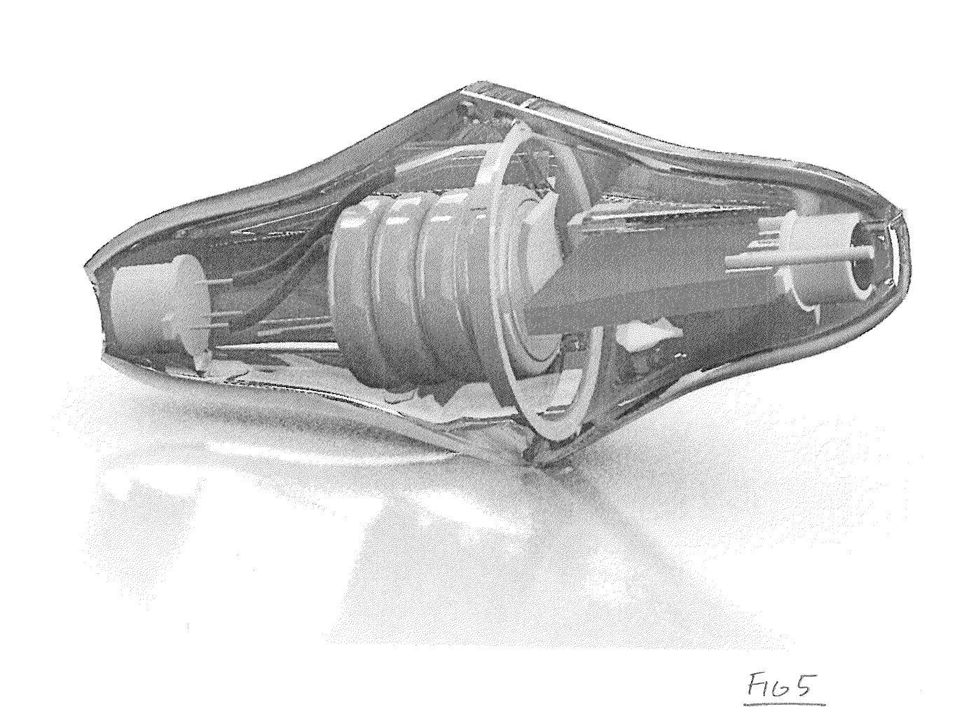

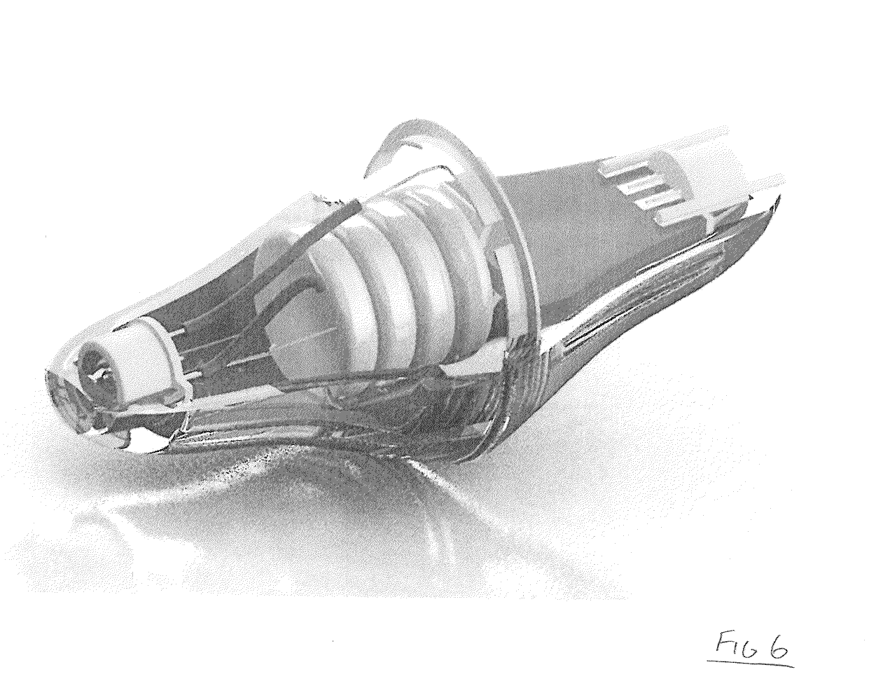

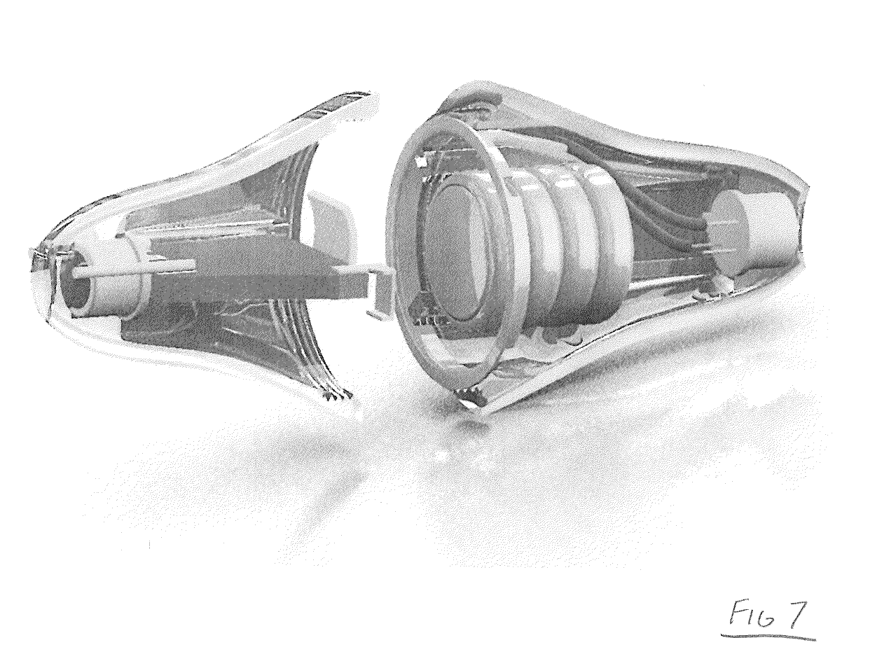

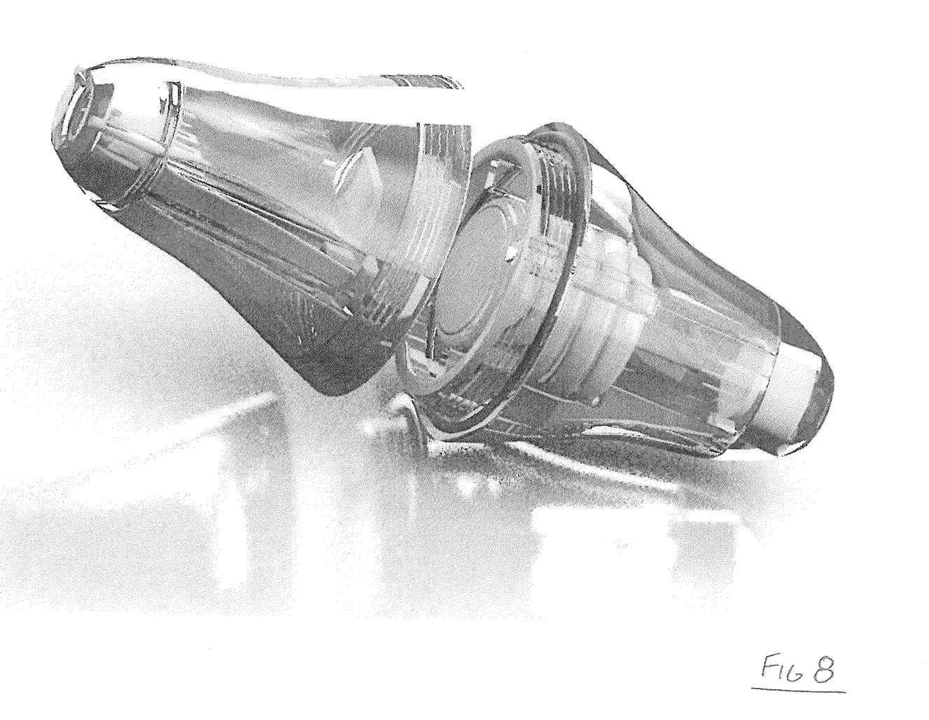

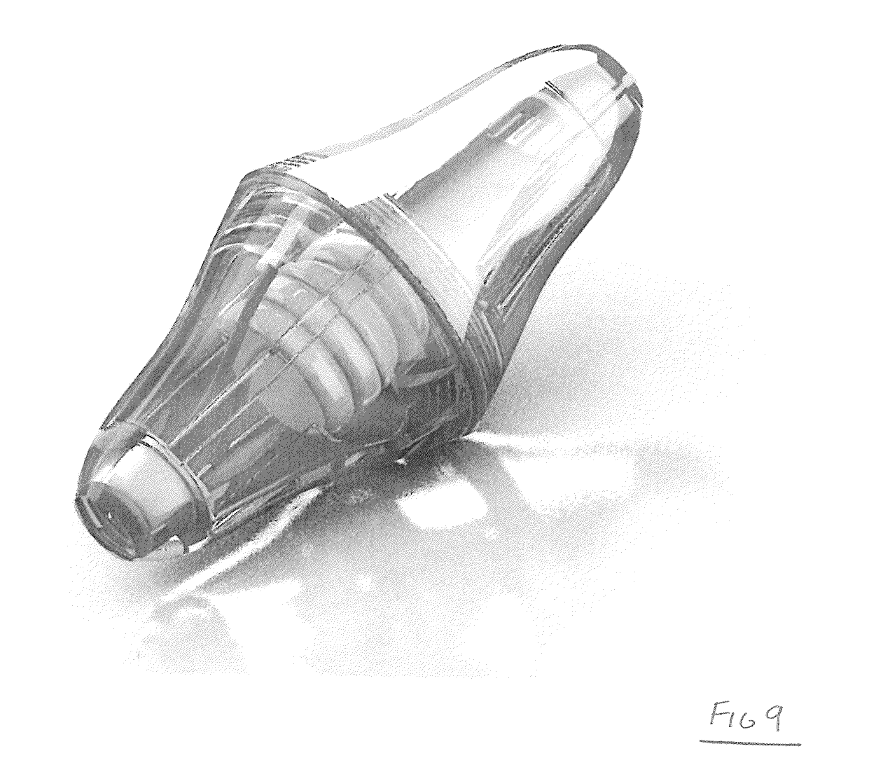

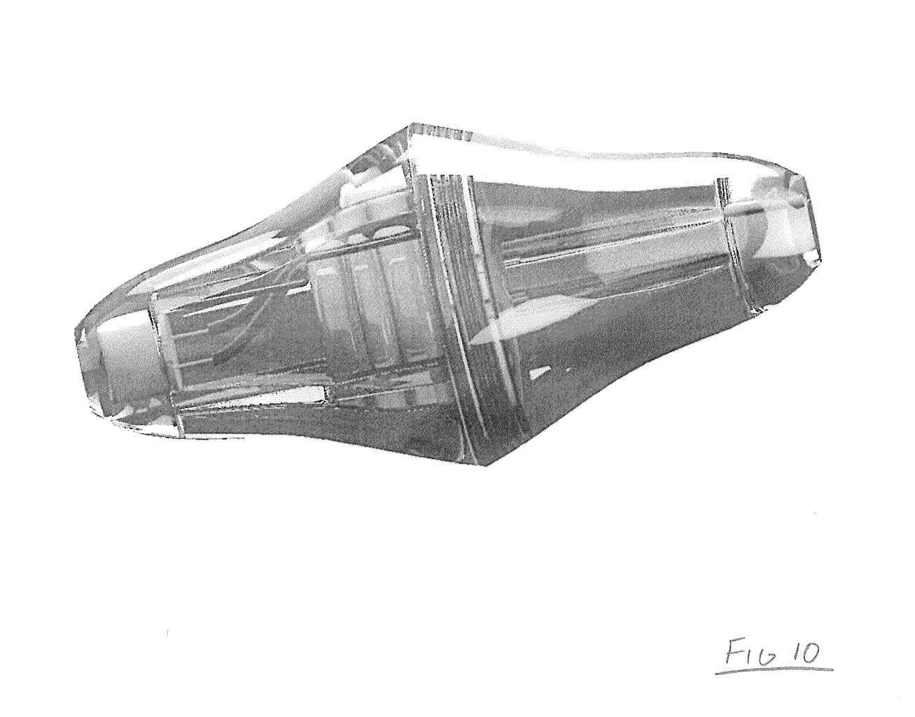

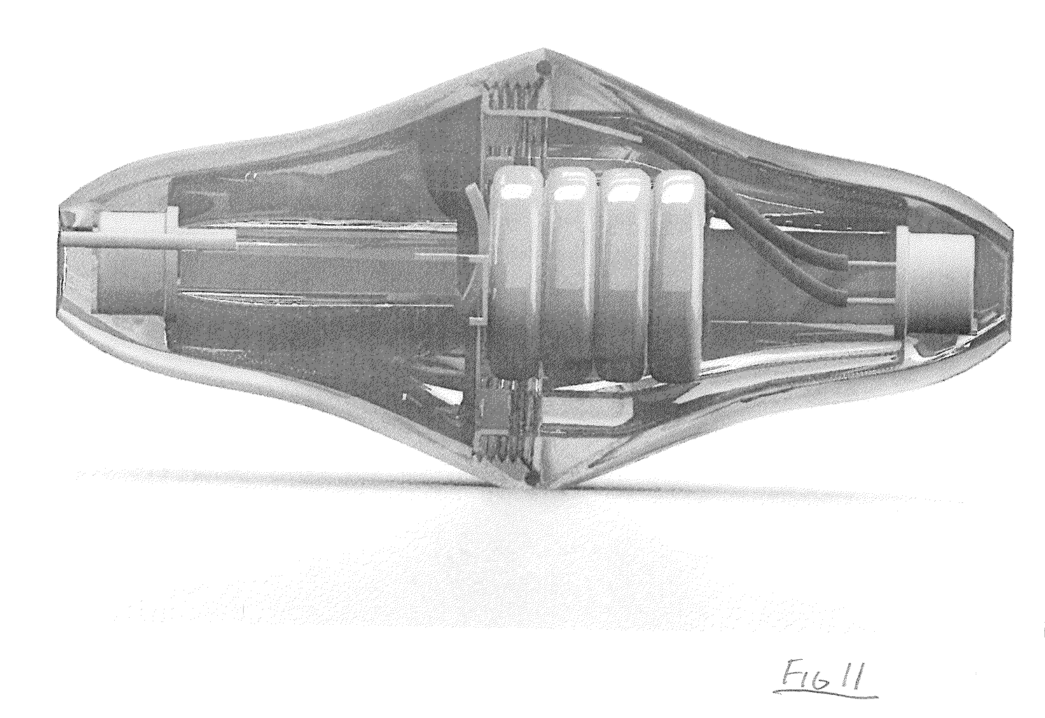

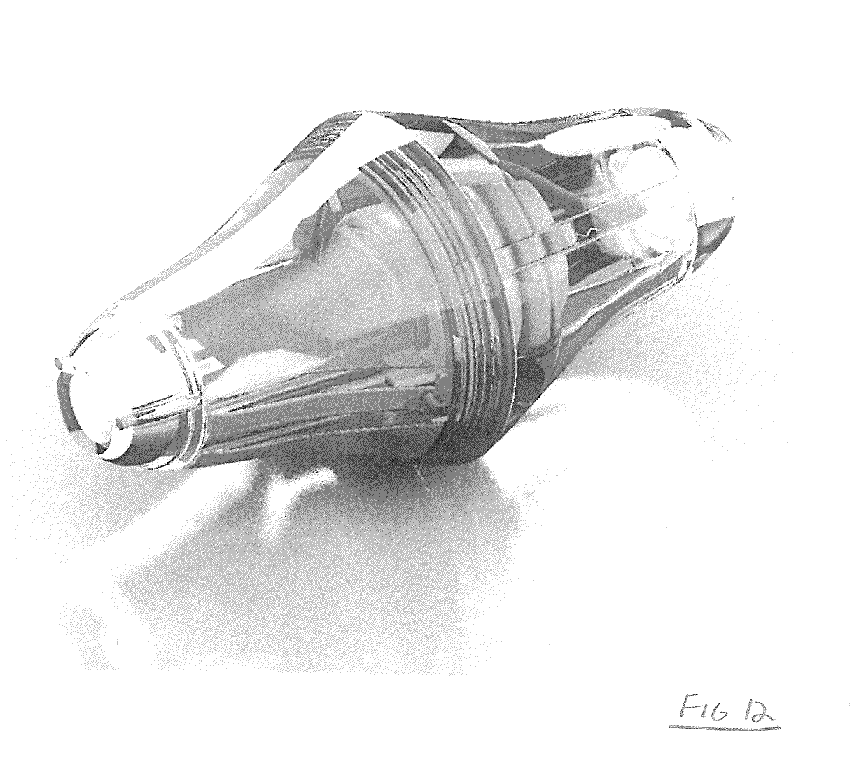

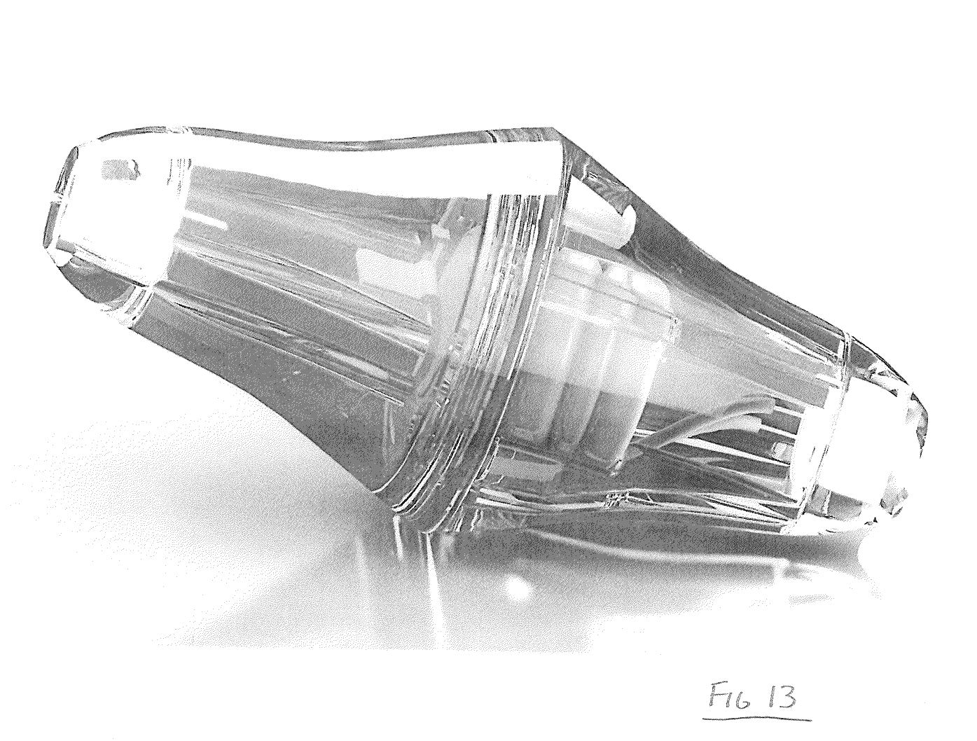

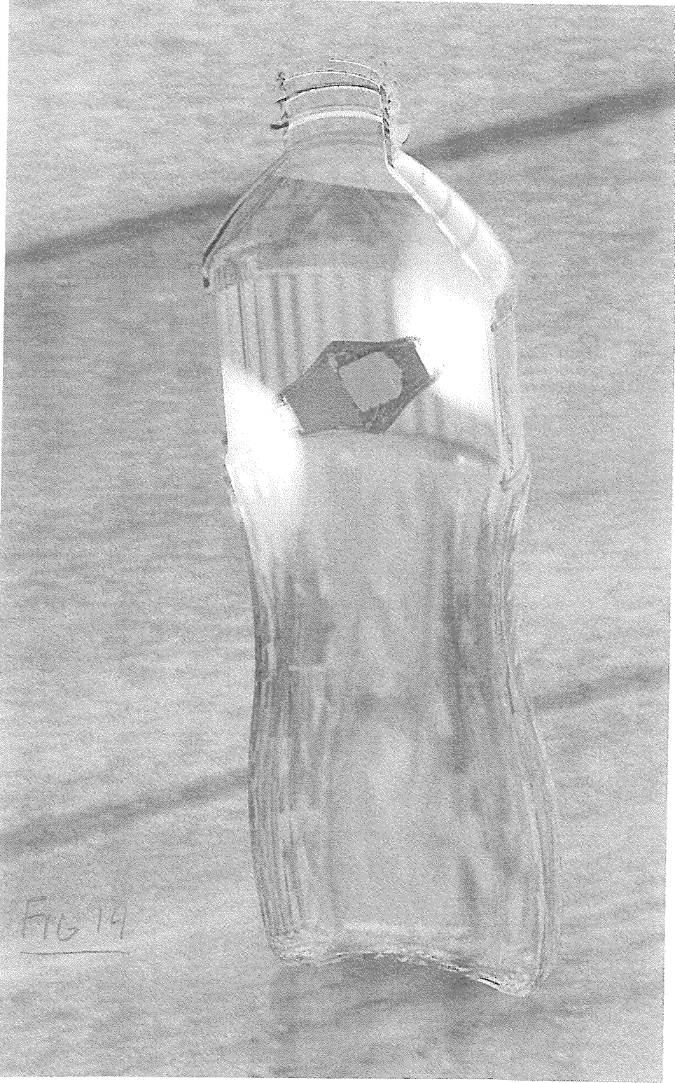

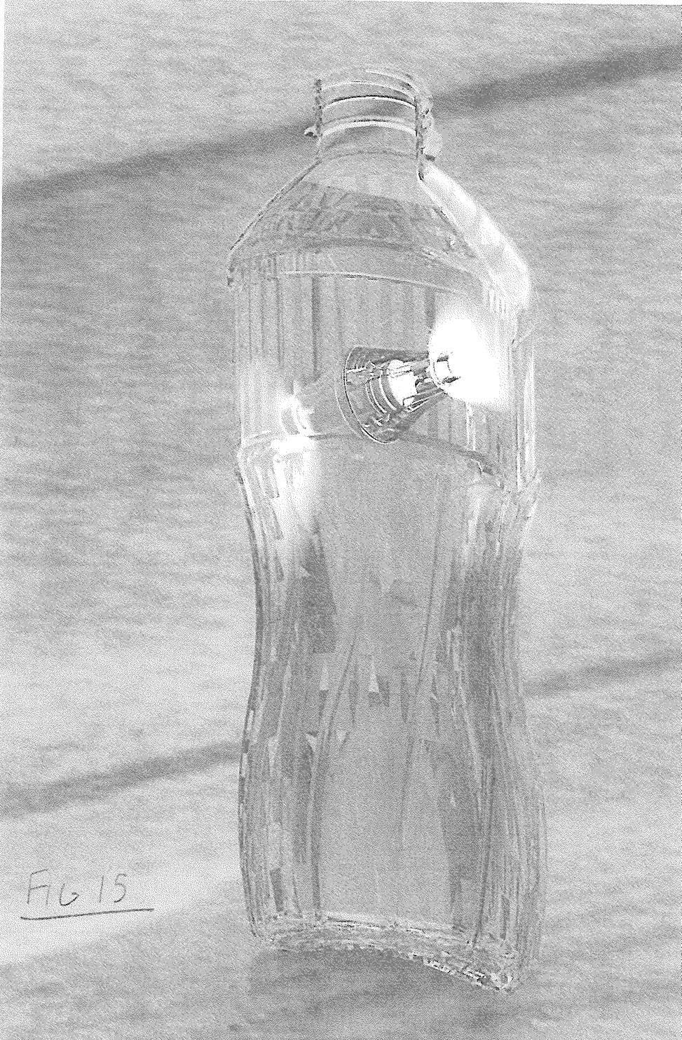

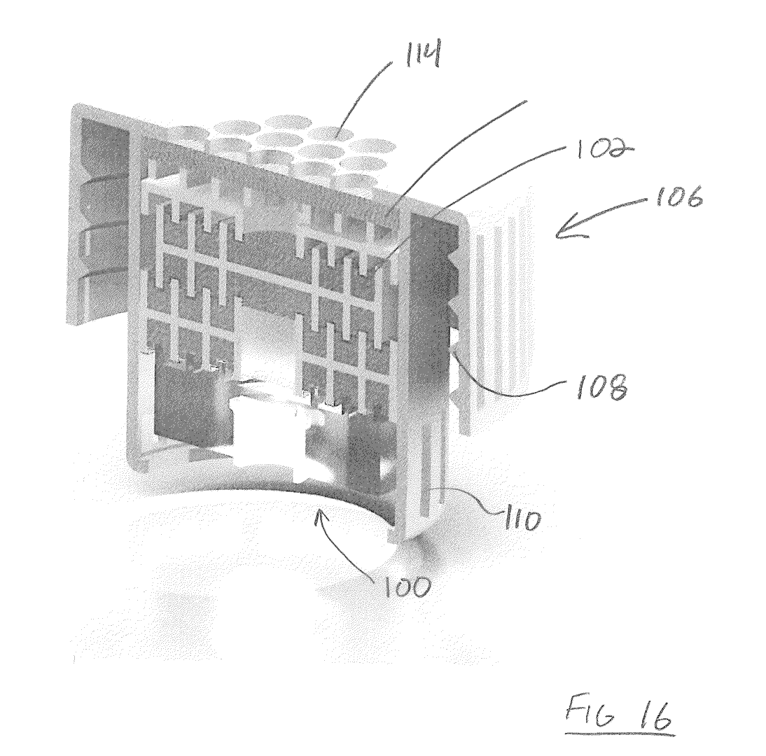

FIG. 3 depicts an embodiment of a water purifier 11 with the upper half 67 connected to the lower half 74. FIG. 4 depicts an end view of the water purifier 11, wherein the batteries 65 may be seen inside the water purifier 11. The batteries 65 are held in place by a battery retaining clip 75.

Returning to FIG. 3, when upper half 67 and the lower half 74 are connected by screwing the threads 64 of each half together, an electrical connection is made in order to provide power to each UVC LED 69. When the two halves are connected securely, a button on the controller 71 can be pressed to begin a delay, e.g. 20-30 seconds, before the UVC LED's 69 are powered on. This gives the user time to insert the apparatus into a selected reservoir/container of water before the UVC LEDs 69 are engaged. Once on, the UVC LEDs 69 receive power from the batteries 65 for a predetermined amount of time according to the size of the UVC apparatus (size and amount of lights/power) being used in relation to the size of the water reservoir/container in order to deliver an effective dose of ultraviolet germicidal radiation (e.g. 1 mw per milliliter). The timer portion of the controller 71 then turns the water purifier 11 off. In some embodiments such an effective dose of ultraviolet germicidal radiation can be achieved with exposure between 30-90 seconds, although one of ordinary skill in the art will recognize that the exposure time will vary with alternative embodiments.

In embodiments of the water purifier 11, the batteries 65 are disposable batteries. In an alternative embodiment, the batteries 65 are rechargeable batteries. In a still further embodiment, the rechargeable batteries are electrically connected to a source of electrical energization, such as solar cells (not depicted) located in the water purifier 11. The solar cells receive ambient light, exemplarily from the sun, to recharge the rechargeable batteries before the water purifier 11 is placed into use. It is understood that in alternative embodiments of the water purifier 11, the rechargeable batteries could also be charged in a variety of other ways including, but not limited to, plug and inductive electrical service chargers, and kinetic energy chargers.

As referenced above, two colored LED lights are located in the upper half 67. These colored LEDs indicate the operation of the “timer” function 66 (counting down until UVC LED activation) and “power” 68. The water purifier 11 can also be operated by using an LCD control display (not depicted). The unit can then be removed from the reservoir/container by a tether (not depicted) or by pouring it out of the reservoir/container.

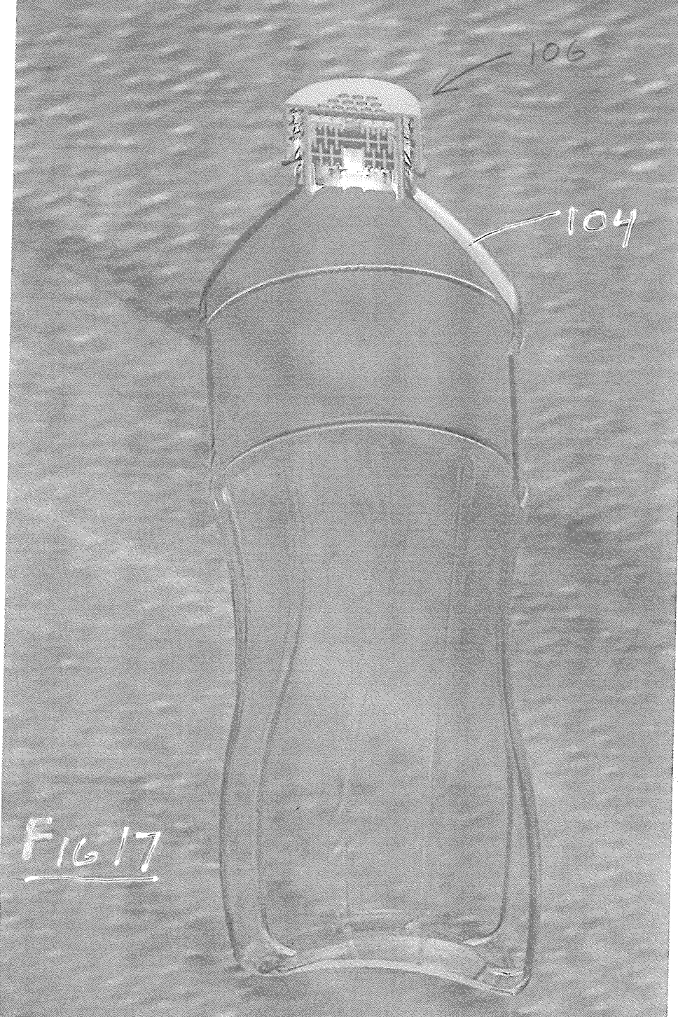

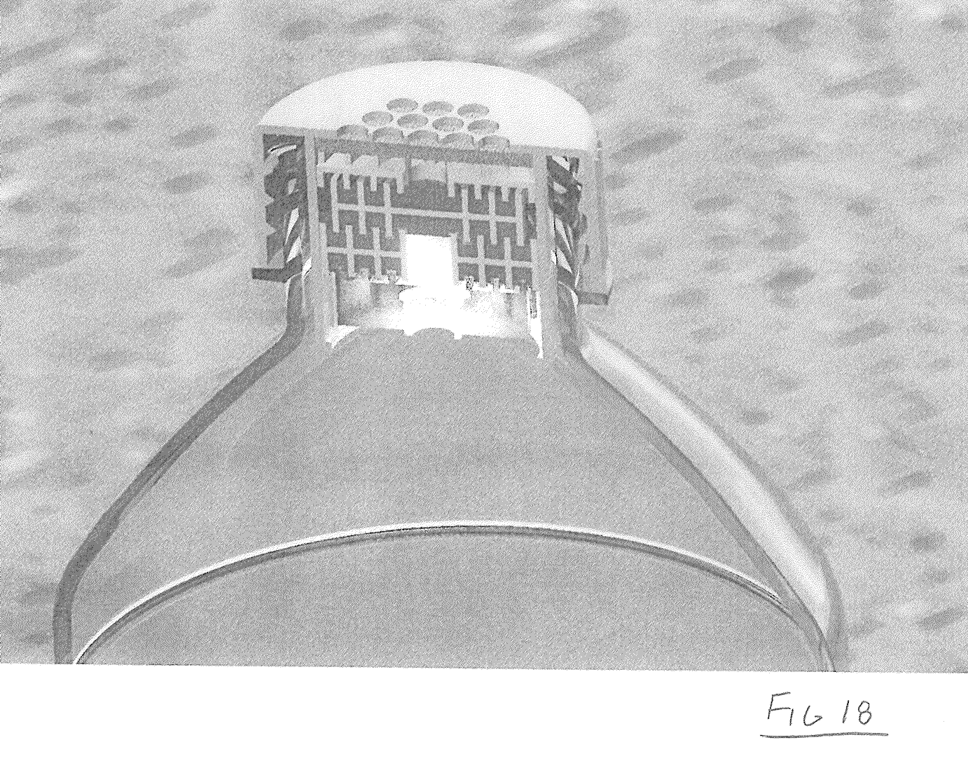

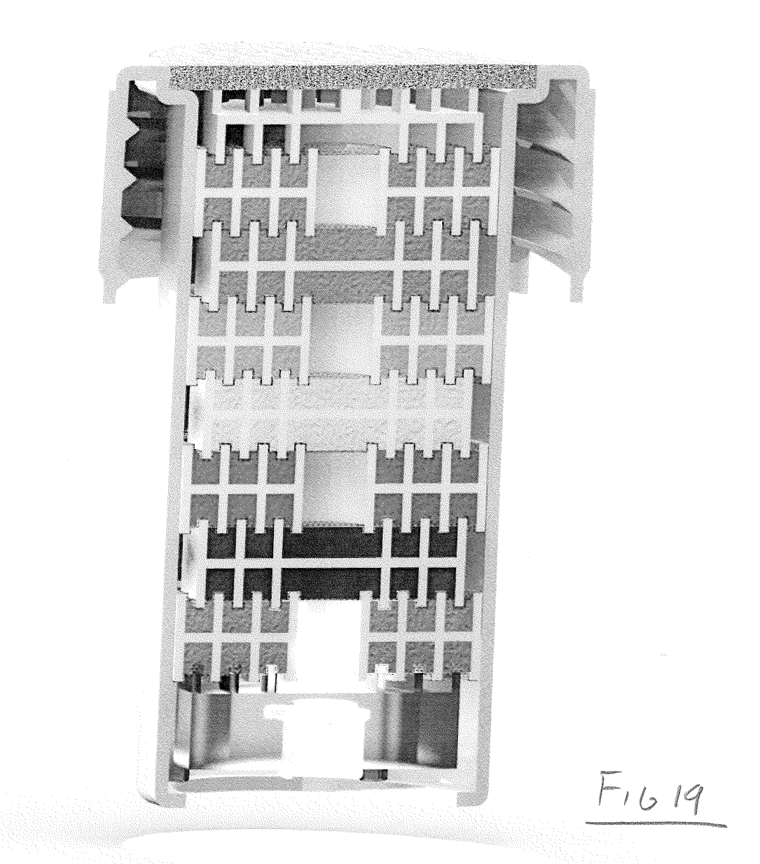

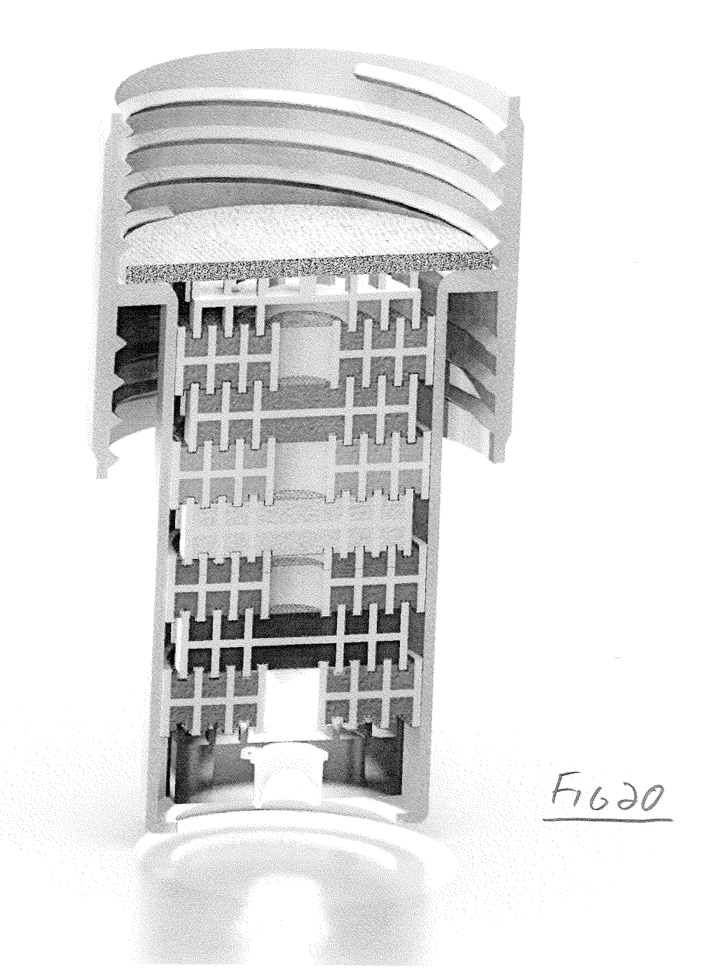

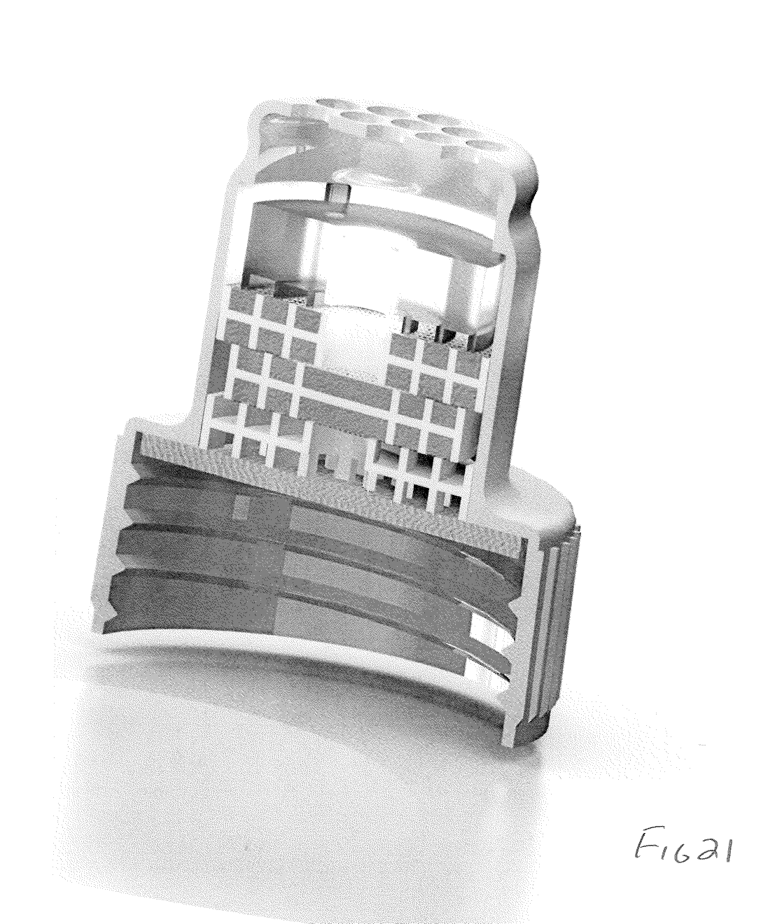

In an alternative embodiment, the water purifier 100 with the components as described above with respect to FIGS. 1-4 can alternatively be used in conjunction with a filter 102 secured to the mouth of a drinking container 104 to filter particulate matter as the water enters the container. One such alternative embodiment is depicted in FIGS. 16-18. The filter 102 can include, but is not limited to: microfiber activated carbon, ion exchange resins, montmorillonite, bentonite, zeolite, garnet, greensand, banana peel fiber, ceramic, redox alloys, anthracite, manganese greensand, calcite, manganese dioxide, ilmenite, and activated alumina. The filter can be screwed into the external threads of drinking containers or by simply holding the filter against the surface of the container opening. A rubber seal around the filter will reduce the amount of particulate matter that is allowed to pass between the opening of the drinking container 104 and the top of the filter 102.

In still further embodiments, the water purifier 100 is used in conjunction with other types of filters including an activated carbon filter, an anion exchange resin filter and a cation exchange resin filter. Each of these filters are known by those of ordinary skill in the water purification art and could be selected for the type of pre-filtering to be performed before the water is treated by the UVC light. In one embodiment, the prefilter is selected to remove UVC light absorbing compounds or substances, as these may affect the length of time of UVC exposure required for purification, or alternatively affect the overall purification results from the UVC exposure.

In an alternative embodiment, the prefilter and the water purifier 100 are structurally connected into a single unit 106 such that water flowing into or out of the container will flow past or through both devices. This single unit may include a connector such as to create threaded or friction fit connection in order to secure the single unit to an independent container 104, such as a water bottle. In an alternative embodiment, one or more of the prefilter and the water purifier 11 are integral components of the reservoir/container. In such an embodiment, the water purifier 11 and its components can be arranged such as to maximize the exposure of the water in the container to the UVC light.

With additional reference to FIGS. 16-18, in some such embodiments the bottle cap 106 serves to hold the water purifier 100 in a relation such as to direct the generated UVC radiation into the water bottle 104. In such an embodiment, the outer shell of the water purifier may be formed to create the bottle cap and connector 108. Slots 110 in the bottle cap 106 can direct water through filter media 102 and/or post physical filter 112, e.g. a member filer, before exiting the bottle cap 106 through holes 114.

In an alternative embodiment of the water purifier, the outer shell can be configured with two or more connectors such that an embodiment of the water purifier can be attached in-line between water conveyance tubes, pipes, or hoses. In such embodiments, the water purifier can purify water as the water flows through the water conveyance apparatus. As such embodiments can be configured to handle various or varying water flow rates. In some embodiments, the water purifier can be wired or wirelessly connected to a computer such as to monitor the operation and/or performance of the water purifier. In a still further embodiment, a continuous flow system through the water purifier is configured such that water flow continues through the water purifier while one or more of filters, lights, or batteries are changed, recharged, or replaced.

As noted above, embodiments of the water purifier 11 are constructed with a polycarbonate outer shell. It will be recognized by one of ordinary skill in the art that alternative material can be used for the outer shell, LED lens, or a filter cartridge including other compositions of plastics. Additionally, the outer shell, LED lens, or a filter cartridge can be constructed from a variety of new composite materials.

Composite materials offer new opportunities for improved characteristics such as strength, stiffness, and electrical conductivity at decreased weights. Composite materials further provide opportunities for improving characteristics such as corrosion resistance and electrical and thermal insulation.

The individual materials that make up a composite material are typically called constituents. Often, one constituent is a binder and the other material is a reinforcement. The binder typically forms a matrix which holds the reinforcement material. The reinforcement material is usually stronger than the binder material.

Reinforcement materials usually comprise one or more types of fiber material. The most common materials for reinforcements include fiberglass, carbon fiber, metals, and glasses. Additionally, various bio-fibers may be used in the reinforcement. Bio-fibers may include fibers from grains or cellulosic materials. These may come from any part of a crop or plant including corn, soybean, wheat, barley, oats, sorghum, sunflower, safflower, buckwheat, flax, peanut, rice, rape/canola, rye, millet, triticale, chickpeas, lentils, and field peas. Alternatively, the biologic materials may come from agricultural wastes such as straw, sawdust, wood chips, news print, or paper. Furthermore, refined products such as flour or grain processing byproduct may further be used.

Matrix materials are typically in the form of petroleum based plastic resins, as would be recognized by one of ordinary skill in the art. Resins are liquid polymers that can fill in the spaces around the reinforcements that when canalized will cure into a solid. Common plastic resin type matrixes include, for example, polyurethane, polypropylene, polyethylene, polyvinylchloride, epoxy, polyester, and vinyl ester. While synthetic petroleum based resins are often used, there are also known bioresins such as isocyanate (e.g. PMDI) and polyol soybean oil and others as would be recognized by persons of ordinary skill in the art.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial difference from the literal languages of the claims.

Various alternatives and embodiments are contemplated as being within the scope of the following claims, particularly pointing out and distinctly claiming the subject matter regarded as the invention.

What is claimed is:

1. A water purifier comprising:
an outer shell that at least partially defines an open interior;
at least one UVC light emitting diode (LED) at least partially disposed within the open interior; and
a controller disposed within the open interior and communicatively connected to the at least one UVC LED, the controller operates the UVC LED to emit UVC band electromagnetic energization for a predetermined time period to kill microorganisms.

2. The water purifier of claim 1, wherein the outer shell comprises a first half and a second half that combine to form a fluid impervious seal about at least a portion of the open interior.

3. The water purifier of claim 1, further comprising an activation button communicatively connected to the controller, wherein upon receiving a signal indicative of activation of the activation button, the controller initiates a delay timer before operating the at least one UVC LED to exist UVC band electromagnetic energization.

4. The water purifier of claim 1, wherein the outer shell further comprises a connector configured to secure the water purifier to a water container.

5. The water purifier of claim 4, wherein the open interior of the outer shell further comprises a filter medium to treat water in the water container.

6. The water purifier of claim 5, wherein the filter media is a prefilter configured to remove UVC absorbent particulates from water entering the water container.

7. The water purifier of claim 5, wherein the filter media is configured to remove particulate matter from water in the water container.
